(19) United States
(12) Patent Application Publication
(10) Pub. No.: US 2006/0016195 A1
(43) Pub. Date: Jan. 26, 2006

(54) Bypass and injection method and apparatus for gas turbines

(75) Inventors: Ralph A. Dalla Betta, Mountain View, CA (US); Kare Lundberg, Gilbert, AZ (US); Timothy Caron, Mountain View, CA (US); Suresh Vilayanur, Santa Clara, CA (US)

Correspondence Address: MORRISON & FOERSTER LLP, 755 PAGE MILL RD, PALO ALTO, CA, 94304-1018, US

(73) Assignee: Catalytica Energy Systems, Inc., Mountain View, CA (US)

(21) Appl. No.: 11/148,866

(22) Filed: Jun. 8, 2005

Related U.S. Application Data
(63) Continuation of application No. 10/664,495, filed on Sep. 16, 2003.

(51) Int. Cl. F02C 7/00

(52) U.S. Cl. 60/772; 60/39.23

(57) ABSTRACT

A bypass air injection scheme for a combustor of a gas turbine. Combustor includes a body with an inner liner and a casing enclosing the body with a passageway defined therebetween. A predetermined amount of the compressor discharge air passing through the passageway is extracted through a manifold. A conduit feeds the extracted air into an injection manifold having a plurality of injection tubes for injecting the extracted air into the combustor bypassing the reactor. The injection tubes and the injection manifold are disposed in a substantially common radial plane.

The present invention relates to gas turbines, and more particularly, relates to a bypass air injection apparatus and method to increase the effectiveness of the combustor by quenching the combustion process.

### BACKGROUND OF THE INVENTION

Gas turbine manufacturers are currently involved in research and engineering programs to produce new gas turbines that will operate at high efficiency without producing undesirable air polluting emissions. The primary air polluting emissions usually produced by gas turbines burning conventional hydrocarbon fuels are oxides of nitrogen, carbon monoxide and unburned hydrocarbons.

Catalytic reactors are generally used in gas turbines to control the amount of pollutants as a catalytic reactor burns a fuel and air mixture at lower temperatures, thus reduces pollutants released during combustion. As a catalytic reactor ages, the equivalence ratio (actual fuel/air ratio divided by the stochiometric fuel/air ratio for combustion) of the reactants traveling through the reactor needs to be increased in order to maximize the effectiveness of the reactor. Thus, there is a need to compensate for the degradation of the catalytic reactor.

### BRIEF SUMMARY OF THE INVENTION

Accordingly, the present invention is directed to a bypass air injection apparatus and method to compensate for the degradation of a catalytic reactor and to increase combustor efficiency by extracting compressor discharge air prior to its entry into a combustion or reaction zone of the combustor, and re-injecting the extracted compressor discharge air into the combustor bypassing the catalytic reactor using a plurality of injection tubes located substantially in a common radial plane with an injection manifold. Compressor discharge air is received by the combustor in a first combustion chamber through a passageway, preferably an annulus defined between a combustor body with an inner liner and a casing enclosing the body. The first combustion chamber includes a pre-burner stage where fuel is mixed with compressor discharge air for combustion, thus raising the temperature of the hot gases sufficiently to sustain a reaction with the catalyst disposed downstream of the first combustion chamber. Hot gases flowing out of the first combustion chamber pass through a main fuel premixer (MFP) assembly for combustion in a main combustion chamber disposed downstream of the catalyst.

A predetermined amount of compressor discharge air, flowing through the annulus, and prior to reception in the first combustion chamber, is extracted into a manifold. The extraction manifold is disposed adjacent to an array of openings located in the casing enabling compressor discharge air to flow from the annulus into the extraction manifold. A bypass conduit connects the extraction manifold to an injection manifold. The injection manifold lies in communication with a plurality of injection tubes for injecting the extracted air into the combustor body bypassing the catalyst. As noted above, each injection tube and the injection manifold are disposed in a substantially common radial plane. Removable flange covers are provided on the injection manifold in substantial radial alignment with the respective injector tubes affording access to the tubes. The injection tubes are installed from the outside of the injection manifold at circumferentially spaced locations about the casing and the liner through flange covers. A bypass air (i.e., extracted air) path is therefore provided to bridge the backside cooling airflow annulus disposed between the combustor casing and the combustion liner.

In another embodiment, the combustor includes only one combustion chamber. Thus, the combustor is devoid of the catalyst and the MFP assembly. Here, main combustion occurs at the pre-burner stage where a greater amount of fuel is mixed with air in order for combustion to occur.

In one aspect, the present invention provides a combustor for a gas turbine having a combustor body, a casing enclosing the combustor body and defining an annular passageway therebetween for carrying compressor discharge air into the combustor body at one end thereof; a reaction zone within the combustor body for main combustion of fuel and air, a first annular manifold surrounding the casing and arranged to extract a predetermined amount of compressor discharge air from the annular passageway, a second annular manifold surrounding the casing and arranged to receive the extracted air, the second manifold located downstream of the first manifold in a combustion flow direction; a conduit for supplying the extracted air from the first manifold to the second manifold; and a plurality of injection tubes in communication with the second manifold for injecting the extracted air into the combustor body downstream of the reaction zone in the combustion flow direction to quench combustion, the injection tubes and the second manifold being disposed in a substantially common radial plane.

In another aspect, the present invention provides a combustor for a gas turbine including a combustor body with an inner liner, a casing enclosing the body and defining a passageway therebetween for carrying compressor discharge air, a catalytic reactor disposed in the body for controlling pollutants released during combustion; a first manifold for extracting a predetermined amount of compressor discharge air from the passageway, a second manifold for receiving the extracted air and supplying the extracted air to the body at a location bypassing the catalytic reactor, and a plurality of injection tubes in communication with the second manifold for injecting the extracted air into the body, the injection tubes and the second manifold being disposed in a substantially common radial plane.

In another aspect, the present invention provides a gas turbine having a compressor section for pressurizing air; a combustor for receiving the pressurized air; and a turbine section for receiving hot gases of combustion from the combustor, the combustor including a combustor body with an inner liner, a casing enclosing the body and defining a passageway therebetween for carrying compressor discharge air, a reaction zone within the combustor body for combustion of fuel and air, a first manifold surrounding the casing and arranged to exhaust a predetermined amount of compressor discharge air from the passageway, a second manifold surrounding the casing and arranged to receive the extracted air, the second manifold located downstream of the first manifold in a combustion flow direction; a conduit for supplying the extracted air from the first manifold to the second manifold; and a plurality of injection tubes in communication with the second manifold for injecting the extracted air into the combustor body downstream of the reaction zone in the combustion flow direction to quench combustion, the injection tubes and the second manifold are disposed in a substantially common radial plane.

In yet another aspect, the present invention provides a method for quenching combustion by extracting a predetermined amount of compressor discharge air, before the air flows into the reactor, from the passageway into the first manifold; supplying the extracted air from the first manifold to the second manifold via the conduit; injecting the extracted air received by the second manifold into the body at a location along the body bypassing the reactor using an array of injection tubes; and disposing the injection tubes and the second manifold in a substantially common plane.

In another aspect, the present invention provides a gas turbine having a compressor section for pressurizing air, a combustor for receiving the pressurized air, and a turbine section for receiving hot gases of combustion from the combustor, the combustor including a combustor body with an inner liner, a casing enclosing the body and defining a passageway therebetween for carrying compressor discharge air, a reaction zone within the combustor body for combustion of fuel and air, a first manifold surrounding the casing and arranged to exhaust a predetermined amount of compressor discharge air from the passageway, a second manifold surrounding the casing and arranged to receive the extracted air, the second manifold located downstream of the first manifold in a combustion flow direction; a conduit for supplying the extracted air from the first manifold to the second manifold; and a plurality of injection tubes in communication with the second manifold for injecting the extracted air downstream of the reaction zone in the combustion flow direction, wherein said injection tubes include a feedhole configuration adapted to channel air from the second manifold.

The present invention is better understood upon consideration of the detailed description below in conjunction with the accompanying drawings and claims.

### BRIEF DESCRIPTION OF THE DRAWINGS

FIG. 1 is a schematic cross-sectional illustration of a combustor forming a part of a gas turbine and constructed in accordance with the present invention;

FIG. 2 is a detailed illustration of the injection manifold and the bypass injection scheme of the present invention;

FIG. 3 illustrates another embodiment of the invention wherein a catalytic reactor is removed from the combustor;

FIG. 4 shows a section of the combustor casing, of FIG. 1, having an array of openings for extracting compressor discharge air;

FIG. 5 illustrates an exemplary injection tube design;

FIGS. 6A and 6B illustrates an exemplary injection tube;

FIG. 7 illustrates an exemplary configuration of a plurality of injection tubes; and

FIG. 8 illustrates an exemplary flow conditioner.

### DETAILED DESCRIPTION OF THE INVENTION

As is well known, a gas turbine includes a compressor section, a combustion section and a turbine section. The compressor section is driven by the turbine section typically through a common shaft connection. The combustion section typically includes a circular array of circumferentially spaced combustors. A fuel/air mixture is burned in each combustor to produce the hot energetic gas, which flows through a transition piece to the turbine section. For purposes of the present description, only one combustor is discussed and illustrated, it being appreciated that all of the other combustors arranged about the turbine are substantially identical to one another.

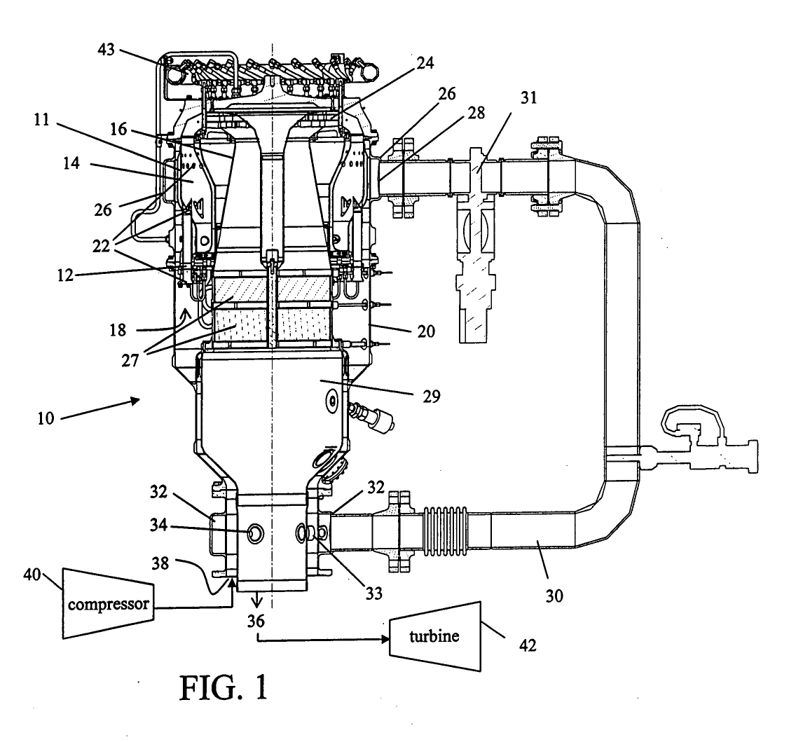

Referring now to FIG. 1, there is shown a combustor generally indicated at 10 for a gas turbine including a fuel injector assembly 12 having a single nozzle or a plurality of fuel nozzles (not shown), a cylindrical combustor body 16, and a casing 20 enclosing the body 16 thereby defining a passageway 18, preferably an annulus 18 therebetween. An ignition device (not shown) is provided and preferably comprises an electrically energized spark plug. Discharge air received from a compressor 40 via an inlet duct 38 flows through the annulus 18 and enters the body 16 through a plurality of holes 22 provided on the pre-burner assembly 11. Compressor discharge air enters body 16 under a pressure differential across the pre-burner assembly 11 to mix with fuel from the fuel injector assembly 12. The mixture is burnt by the pre-burner assembly 11. Combustion occurs in a first combustion chamber or first reaction zone 14 thus raising the temperature of the combustion gases to a sufficient level for the catalyst 27 to react. Combustion air from the first combustion chamber 14 flows through a main fuel premixer (MFP) assembly 24 and then through catalyst 27 into the main combustion chamber or main reaction zone 29 for combustion. Additional fuel is pumped into the MFP assembly to mix with hot gases, exiting the first combustion chamber 14, and reacts through catalyst 27 thus producing a combustion reaction in the main combustion chamber 29, whereby the hot gases of combustion pass through a transition piece 36 to drive the turbine 42.

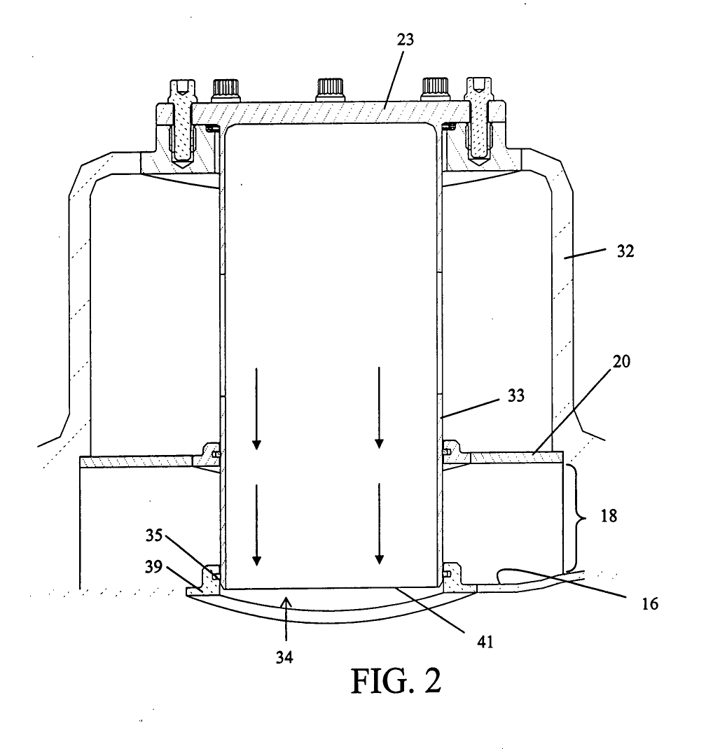

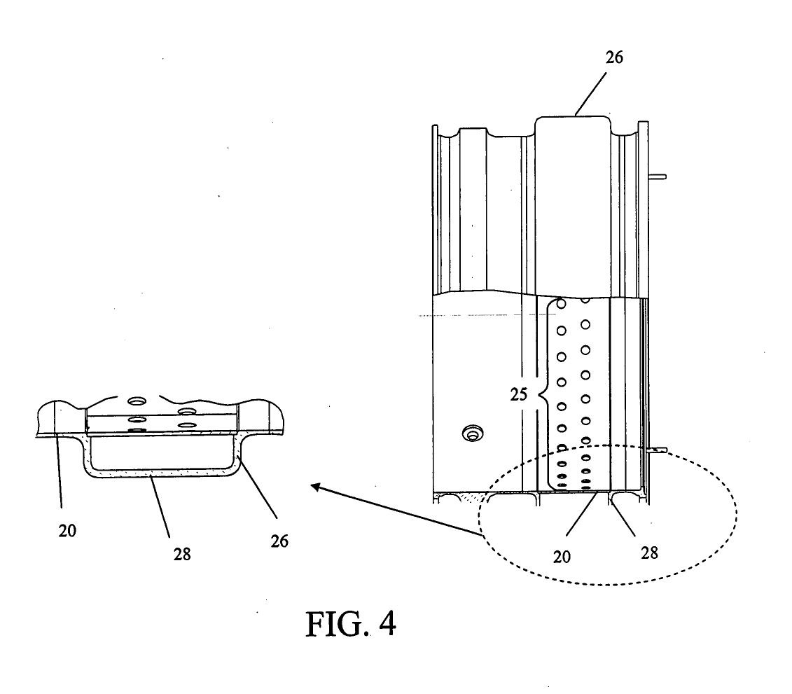

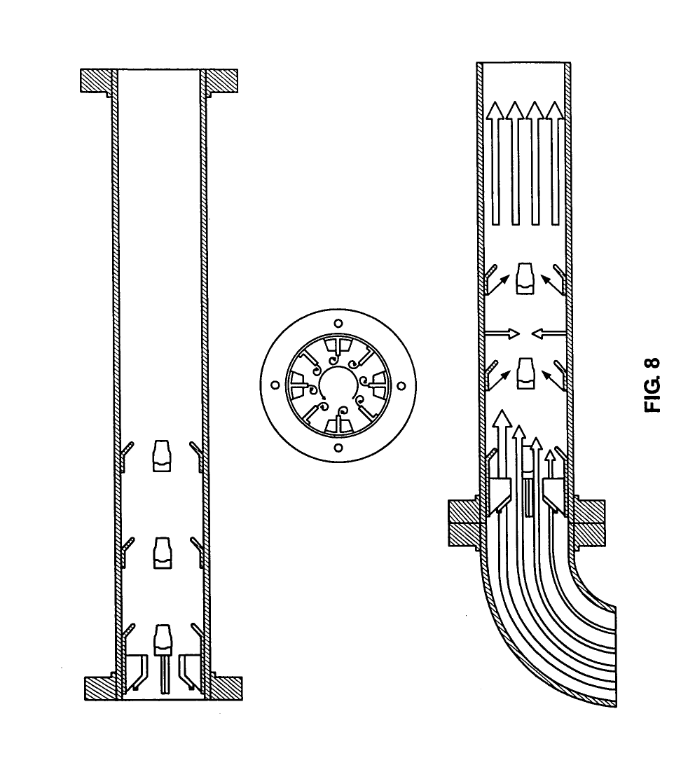

A predetermined amount of the compressor discharge air is extracted from the annulus 18 into a manifold 26 via an array of openings 25 (FIG. 4) located in casing 20 and leading into an opening 28 which sealingly mates with one end of a bypass conduit 30, while a second end of conduit 30 leads into an injection manifold 32. A valve 31 regulates the amount of air supplied to manifold 32. Additionally, a metering device such as an annubar flow-meter may be included to measure the quantity of air passing through conduit 30, and a low pressure drop flow conditioner device such as VORTAB™ flow conditioner (see, e.g., FIG. 8) or perforated plate conditioner may be included that prepares the flow for more accurate flow measurements. Suitable metering devices include devices based on differential pressure or other suitable flow meters. A suitable metering device may further be advantageously coupled to a control system. Air received in manifold 32 is injected by a plurality of injection tubes 33 into body 16, bypassing catalyst 27. Each of the injection tubes 33 and manifold 32 are located substantially in a common radial plane. Further, each injection tube opens into body 16 through apertures 34 (FIG. 2). Removable flange covers 23 are provided on the injection manifold in substantial radial alignment with the respective injector tubes 33 affording access to the tubes. The injection tubes are installed from the outside of the injection manifold at circumferentially spaced locations about the casing and the liner through flange covers. Members 35 and 39 (FIG. 2) cooperate to secure each injection tube 33 to body 16 in a floating piston seal to provide a sealingly tight connection. Thus, injected air cools the reaction and quenches the combustion process.

Other exemplary bypass and injection systems are described in U.S. Pat. Nos. 6,449,956 and 6,568,188 both entitled “BYPASS AIR INJECTION METHOD AND APPARATUS FOR GAS TURBINES,” and both of which are incorporated by reference as if fully set forth herein.

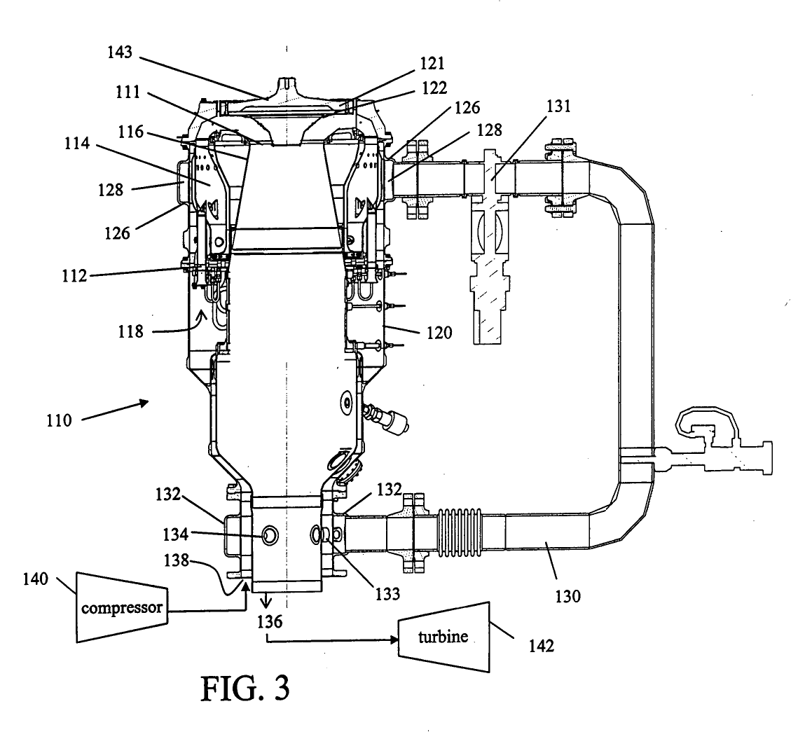

Referring to FIG. 3, a second embodiment is illustrated wherein like elements as in the combustor of FIG. 1 are indicated by like reference numerals preceded by the prefix “1”. Here, the combustor 110 comprises a combustion chamber or reaction zone 114 where main combustion occurs. Catalyst 27 and MFP assembly 24 are absent in this embodiment. Here, compressor discharge air from annulus 118 flows into manifold 126, and from manifold 126 via conduit 130 flows into body 116 through injection tubes 133 bypassing the reaction zone 114. Further, the amount of fuel supplied to mix with compressor discharge air is greater than the amount supplied in the presence of a catalyst. It will be appreciated that the location of the reaction zone 114 need not necessarily lie in close proximity to the fuel injector assembly 112. Rather it may be located within body 116 between end member 143 and manifold 132. Likewise, manifold 132 may be appropriately located along casing 120 to inject air into body 116 provided the reaction zone is bypassed in order to quench the combustion process. In other words, the manifold 132 and the injection of compressor discharge air into combustor body occurs downstream of the reaction zone 114 in a combustion flow direction, as apparent from FIG. 3.

Thus, the present invention has the advantages of maximizing the effectiveness of the catalytic reaction, thereby increasing the efficiency of the combustor. The present invention further provides a simple means of controlling the combustion process.

Another aspect of the present invention includes a combustion system having injection tubes adapted to extend into a plenum for receiving bypass air and re-inject the air downstream of the main combustion or reaction zone with reduced pressure drop resulting from flow losses at the injection tube feedholes. In one example, the feedhole sizes and/or shapes are adapted to reduce undesirable pressure drops near the injection tube feedholes. Further, an injection tube having one or more feedholes may be oriented with a greater feedhole area facing a flow of air in the plenum to channel or scoop the air with reduced pressure drops near the feedholes and reduce flow losses of the bypass system.

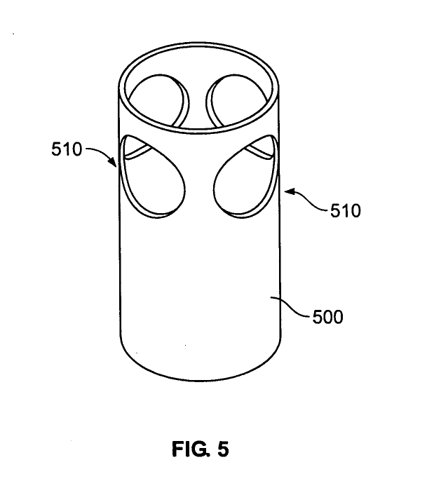

FIG. 5 illustrates an exemplary injection tube 500 including four circular feedholes 510. The injection tube 500 and four circular feedholes 510 extend into a plenum where air is received through feedholes 510 and directed downstream of the reaction zone through injection tube 500. In this example, each feedhole 510 is equally sized and spaced 90 degrees apart around the circumference of the injection tube. Testing and analysis revealed that there were significant losses in pressure near feedholes 510 of the injection tube 500 that may cause a decrease in flow capacity of the bypass system. Generally, increasing the diameter of injection tube 500 and/or the size of feedholes 510 has been found to reduce pressure drops near feedholes 510 thereby improving performance of the bypass system. Further, nonsymmetrical feedhole configurations that may be oriented with respect to an airflow direction have been found to reduce pressure drops near injection tube feedholes and also in the general flowpath.

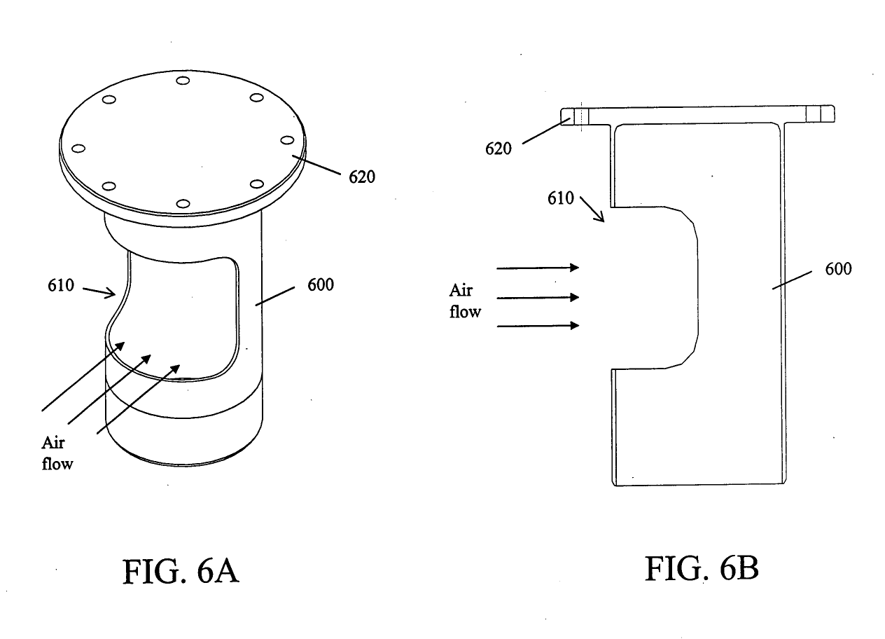

FIGS. 6A and 6B illustrate an exemplary injection tube 600 including a generally rectangular profile “scoop” feedhole design that may reduce pressure drops from the plenum, i.e., manifold 32 of FIG. 1, through the injection tube due to flow losses near the feedhole 610. Additionally, the diameter of the injection tube 600 can be increased to further reduce pressure drops. In one example, the area of the opening of feedhole 610 relative to the outer surface area of injection tube 600 may be increased (as compared to injection tube 500, for example), and may be configured in a bypass system to oppose or face the airflow in a plenum. The larger area feedhole 610 (compared to injection tube 500 and feedhole 510) and configuration facing the airflow allows the injection tube 600 to scoop or channel the air through feedhole 610 with reduced pressure loss near the feedhole 610.

Generally, providing a large area opening in the injection tube allows little air passage out of the openings back into the plenum (e.g., manifold). Further, minimizing structures and tailoring geometries that reduce pressure by reducing or elimination eddies, vortices, and the like increases the bypass performance. Therefore, it is desirable to exclude sharp edges or curves in the openings that may create eddies and pressure fluctuations in the airflow.

Preferably, injection tube 600 includes a single feedhole 610 having a rectangular shaped opening with curved corners to reduce pressure fluctuations from eddies and the like; however, squared corners are possible. In other examples, feedhole 610 may include an elliptical shaped opening or other suitable shape, and injection tube 600 may include any number of feedholes 610 of various shapes and configurations. Additionally, trumpet shaped or NACA (National Advisory Committee for Aerodynamics) duct shape feedholes may also be used.

Generally, it is desired to configure one or more feedholes 610 to have a greater opening or receiving area facing the airflow to scoop or channel air from the airflow with reduced pressure loss near the opening. For example, in FIG. 6B, injection tube 600 has an opening for intaking air from the left side, facing upstream of the airflow, and may thereby scoop air with reduced pressure loss and channel the air downstream of the main reaction zone, e.g., between the reaction zone and the turbine. In other examples, injection tube 600 could include an opening on the opposite side of feedhole 610 with a smaller opening area.

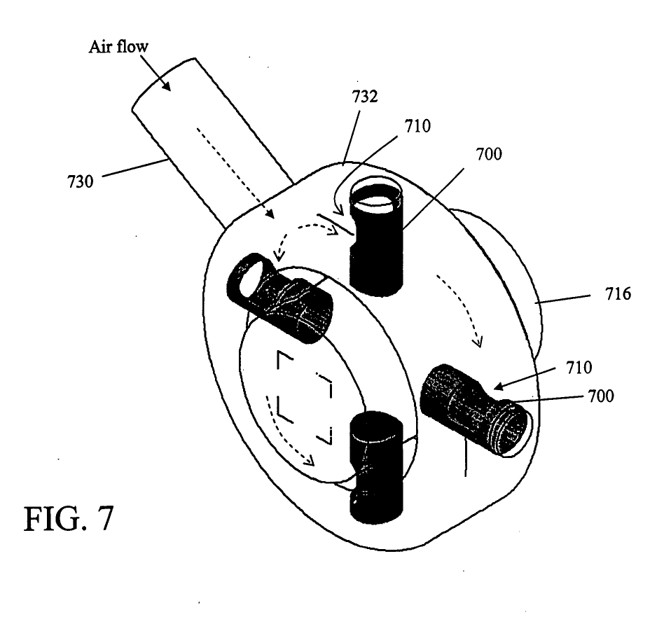

FIG. 7 illustrates a portion of an exemplary bypass system including a plurality of injection tubes 700 configured to scoop air from the plenum, e.g., manifold 732, and inject the air through injection tubes 700 into combustor body 716. Manifold 732 receives air from the conduit 730, and feedholes 710 scoop air from the plenum and feed it to a point in the combustion systems downstream of the main reaction zone. The clocking or orientation of the feedholes 710, shown here as rectangular scoops of the injection tubes 700, may further reduce pressure drops near the feedholes 710. The orientation of the feedholes 710 is relative to the air feed from conduit 730 into the spool shaped manifold 732 as shown generally by the arrows. In particular, feedholes 710 face upstream of the airflow through manifold 732. However, alternative shapes and openings may be clocked differently.

In other examples, computational fluid dynamic analysis may be used to find a desirable orientation of the feedhole 710 relative to airflow based on the airflow characteristics within manifold 732, the configuration of feedholes 710, and the like. Test data has shown that the exemplary injection tubes 700 and design of scoop feedholes 710, as well as increased injection tube 700 diameter, may greatly alleviate flow losses and increases flow capacity of the bypass system. It should be recognized by those of ordinary skill in the art that various feedhole configurations and injection tube configurations discussed herein may be used alone or in combination with various other devices and methods to reduce pressure drops and increase bypass system performance.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A combustor for a gas turbine, comprising:
a combustor body;
a casing enclosing said body and defining a passageway therebetween for carrying compressor discharge air;
a catalytic reactor disposed in said body for controlling pollutants released during combustion;
a first manifold for extracting a predetermined amount of compressor discharge air from said passageway;
a second manifold for receiving the extracted air and supplying the extracted air to said body at a location bypassing said catalytic reactor; and
a plurality of injection tubes in communication with said second manifold for injecting the extracted air into said body, said injection tubes and said second manifold being disposed in a substantially common radial plane.

2. The combustor of claim 1, wherein said casing includes an array of openings adjacent to said first manifold to enable the compressor discharge air to flow through said openings into said first manifold; and
a conduit for supplying the extracted air from said first manifold to said second manifold.

3. The combustor of claim 2, wherein the injection tubes are equally spaced from one another about said second manifold.

4. The combustor of claim 3, wherein first and second ends of said conduit terminate in said first and second manifolds, respectively.

5. The combustor of claim 4, wherein said first and second manifolds are disposed about an outer surface of said casing.

6. In a combustor comprising a body with an inner liner and a casing enclosing said body defining a passageway therebetween, a catalytic reactor disposed within said body, first and second manifolds about said casing, and a conduit for connecting said first and second manifolds, a method for quenching combustion comprising the steps of:
extracting a predetermined amount of compressor discharge air, before the air flows into said reactor, from said passageway into said first manifold;
supplying said extracted air from said first manifold to said second manifold via said conduit;
injecting the extracted air received by said second manifold into said body at a location along the body bypassing said reactor using an array of injection tubes; and
disposing said injection tubes and said second manifold in a substantially common radial plane.

7. In a gas turbine comprising a compressor, a combustor, and a turbine, said combustor including a body with an inner liner, a casing enclosing said body defining a passageway therebetween for carrying compressor discharge air, a catalytic reactor disposed within said body, first and second manifolds disposed about said casing, and a conduit for connecting said first and second manifolds, a method for quenching combustion comprising the steps of:
extracting a predetermined amount of compressor discharge air, before the air flows into said reactor, from said passageway into said first manifold;
supplying said extracted air from said first manifold to said second manifold via said conduit;
injecting the extracted air received by said second manifold into said body at a location along the body bypassing said reactor using an array of injection tubes; and
disposing said injection tubes and said second manifold in a substantially common radial plane.

8. A combustor for a gas turbine, comprising:
a combustor body,
a casing enclosing said combustor body and defining an annular passageway therebetween for carrying compressor discharge air into said combustor body at one end thereof;
a reaction zone within said combustor body for main combustion of fuel and air;
a first annular manifold surrounding said casing and arranged to extract a predetermined amount of compressor discharge air from said annular passageway;
a second annular manifold surrounding said casing manifold and arranged to receive the extracted air, said second manifold located downstream of said first manifold in a combustion flow direction;
a conduit for supplying the extracted air from said first manifold to said second manifold; and
a plurality of injection tubes in communication with said second manifold for injecting the extracted air into said combustor body downstream of said reaction zone in the combustion flow direction to quench combustion, said injection tubes and said second manifold being disposed in a substantially common radial plane.

9. The combustor of claim 8, further comprising:
an array of openings disposed in said casing to permit the compressor discharge air to flow through said openings into said first manifold; and
a conduit for supplying the extracted air from said first manifold to said second manifold.

10. The combustor of claim 9, wherein the injection tubes are equally spaced from one another about said second manifold.

11. The combustor of claim 9, wherein said conduit includes a control valve to regulate air flowing from said first manifold to said second manifold.

12. A gas turbine comprising:
a compressor section for pressurizing air;
a combustor for receiving the pressurized air; and
turbine section for receiving hot gases of combustion from the combustor, said combustor including a combustor body with an inner liner, a casing enclosing said body and defining a passageway therebetween for carrying compressor discharge air, a reaction zone within said combustor body for combustion of fuel and air, a first manifold surrounding said casing and arranged to extract a predetermined amount of compressor discharge air from said passageway, a second manifold surrounding said casing and arranged to receive the extracted air, said second manifold located downstream of said first manifold in a combustion flow direction; a conduit for supplying the extracted air from said first manifold to said second manifold, and a plurality of injection tubes in communication with said second manifold for injecting the extracted air into said combustor body downstream of said reaction zone in the combustion flow direction to quench combustion, said injection tubes and said second manifold being disposed in a substantially common radial plane.

13. A gas turbine according to claim 12, wherein said casing further includes an array of openings adjacent to said first manifold to enable the compressor discharge air to flow through said openings into said first manifold.

14. The gas turbine of claim 13, wherein the injection tubes are equally spaced from one another about said second manifold.

15. A combustor for a gas turbine, comprising:
a combustor body;
a casing enclosing said combustor body and defining a passageway therebetween for carrying compressor discharge air into said combustor body at one end thereof;
a reaction zone within said combustor body for combustion of fuel and air;
a first annular manifold surrounding said casing and arranged to extract a predetermined amount of compressor discharge air from said annular passageway;
a second annular manifold surrounding said casing manifold and arranged to receive the extracted air, said second manifold located downstream of said first manifold in a combustion flow direction;
a conduit for supplying the extracted air from said first manifold to said second manifold; and
a plurality of injection tubes in communication with said second manifold for injecting the extracted air downstream of said reaction zone in the combustion flow direction, wherein said injection tubes include a feedhole configuration adapted to channel air from the second manifold.

16. The combustor of claim 15, wherein the injector tube includes a greater feedhole area facing upstream of a manifold airflow direction than facing downstream of the manifold airflow direction.

17. The combustor of claim 15, wherein the injection tubes include a feedhole opening extending at least one-fourth of the circumference of the outer surface of the injection tube.

18. The combustor of claim 15, wherein at least one feedhole includes a rectangular shaped opening.

19. The combustor of claim 15, wherein at least one feedhole includes an elliptical shaped opening.

20. The combustor of claim 15, wherein the injection tubes each have a single feedhole.

21. The combustor of claim 15, wherein the injection tubes include a plurality of feedholes.

22. The combustor of claim 15, wherein the injection tubes and the second manifold are disposed in a substantially common radial plane.

23. The combustor of claim 15, wherein the injection tubes are equally spaced from one another about the second manifold.

24. The combustor of claim 15, wherein the injection tubes are unequally spaced from one another about the second manifold.

25. The combustor of claim 15, further including a catalytic reactor disposed in the combustor body.

26. The combustor of claim 15, further including a flow metering device to measure the quantity of air passing through the conduit.

27. The combustor of claim 26, further including a low pressure drop flow conditioner located upstream of the flow metering device.

28. The combustor of claim 15, further comprising:
an array of openings disposed in said casing to permit the compressor discharge air to flow through said openings into said first manifold; and
a conduit for supplying the extracted air from said first manifold to said second manifold.

29. The combustor of claim 28, wherein said conduit includes a control valve to regulate air flowing from said first manifold to said second manifold.

30. In a combustor comprising a body with an inner liner and a casing enclosing said body defining a passageway therebetween, a reaction zone within the body for combustion of fuel and air, first and second manifolds about said casing, and a conduit for connecting said first and second manifolds, a method for quenching combustion comprising the steps of:
extracting a predetermined amount of compressor discharge air, before the air flows into said reactor, from said passageway into said first manifold;
supplying said extracted air from said first manifold to said second manifold via said conduit;
injecting the extracted air received by said second manifold at a location downstream of said reaction zone using an array of injection tubes; and
disposing said injection tubes and said second manifold in a substantially common radial plane, wherein said injection tubes include a feedhole configuration adapted to channel air from the second manifold.

31. The method of claim 30, wherein the injection tubes each have a greater feedhole area facing upstream of a manifold airflow direction than facing downstream of the manifold airflow direction.

32. The method of claim 30, wherein the injection tubes include a feedhole opening extending at least one-fourth of the circumference of the outer surface of the injection tube.

33. The method of claim 30, wherein at least one feedhole includes a rectangular shaped opening.

34. The method of claim 30, wherein at least one feedhole includes an elliptical shaped opening.

35. The method of claim 30, wherein the injection tubes each have a single feedhole.

36. The method of claim 30, wherein the injection tubes include a plurality of feedholes.

37. The method of claim 30, wherein the injection tubes and the second manifold are disposed in a substantially common radial plane.

38. The method of claim 30, wherein the injection tubes are equally spaced from one another about the second manifold.

39. The method of claim 30, further including catalytically combusting a portion of the fuel and air in the combustor body.
